(19) United States
(12) Patent Application Publication
(10) Pub. No.: US 2025/0153562 A1
(43) Pub. Date: May 15, 2025

(54) Transmission for a Vehicle, and Powertrain Comprising Such a Transmission

(71) Applicant: ZF Friedrichshafen AG, Friedrichshafen (DE)

(72) Inventors: Ulrich Kehr, Tettnang (DE); Matthias Reisch, Ravensburg (DE)

(21) Appl. No.: 18/835,474

(22) PCT Filed: Jan. 4, 2023
(86) PCT No.: PCT/EP2023/050114

§ 371 Date: Aug. 2, 2024

(30) Foreign Application Priority Data
Feb. 3, 2022 (DE) 10 2022 201 138.4

(51) Int. Cl. B60K 17/04; B60K 1/00; B60K 5/04; F16H 37/08; F16H 57/02; F16H 57/037

(52) U.S. Cl. CPC B60K 17/043; B60K 1/00; B60K 5/04; B60K 17/046; F16H 37/0813; F16H 37/082; F16H 57/037; B60K 2001/001; F16H 2057/0203; F16H 2057/02034; F16H 2057/02052

(57) ABSTRACT

A transmission for a power train of a vehicle has a first sub-transmission in a first housing, a second sub-transmission in a second housing, and a third sub-transmission in a third housing. The first sub-transmission has a first input shaft for introducing drive power, a first output shaft, a second output shaft, and an epicyclic gear train with a first planetary gear set for transmitting a first output torque onto the first output shaft and a corresponding second output torque onto the second output shaft. The second sub-transmission has a second input shaft for conjoint rotation with the second output shaft, and a third output shaft for conjoint rotation with a first vehicle wheel. The third sub-transmission has a third input shaft for conjoint rotation with the first output shaft, and a fourth output shaft for conjoint rotation with a second vehicle wheel.

### CROSS-REFERENCE TO RELATED APPLICATION

The present application is related and has right of priority to German Patent Application No. 10 2022 201 138.4 filed on Feb. 3, 2022 and is a nationalization of PCT/EP2023/050114 filed in the European Patent Office on Jan. 4, 2023, both of which are incorporated by reference in their entirety for all purposes.

### FIELD OF THE INVENTION

The invention relates generally to a transmission for a power train of a vehicle and to a power train having such a transmission.

### BACKGROUND

DE 10 2013 215 877 B4 relates to an epicyclic gear train for branching the drive power applied at a power input to a first power output and to a second power output in conjunction with reducing the output rotational speed to a rotational speed level that is below the input rotational speed at the power input. The epicyclic gear train has a first transmission stage which includes a first sun gear, a first planetary gear set, a first planet carrier, and a first ring gear. The epicyclic gear train also has a second transmission stage which includes a second sun gear, a second planetary gear set, a second planet carrier, and a second ring gear. In addition, the epicyclic gear train has a third planetary gear stage which includes a third sun gear, a third planetary gear set, and a third planet carrier. The first sun gear acts as a power input, wherein the first planet carrier is coupled to the second sun gear for conjoint rotation. The second planet carrier is fixed in position, wherein the first ring gear is coupled to the third sun gear. The first power output is brought about via the third transmission stage, wherein the second power output is brought about via the second ring gear of the second transmission stage. The third transmission stage includes a third ring gear which is coupled to the second planet carrier for conjoint rotation.

### SUMMARY OF THE INVENTION

The problem addressed by the present invention is that of providing an alternative transmission for a power train of a vehicle.

A transmission according to the invention for a power train of a vehicle according to a first aspect of the invention includes a first sub-transmission. The first sub-transmission is arranged in a first housing and has an epicyclic gear train with at least one first planetary gear set having multiple gear set elements. A first gear set element in the at least first planetary gear set is connected to a first input shaft for conjoint rotation. A second gear set element in the at least first planetary gear set is connected to a first output shaft for conjoint rotation. A third gear set element in the at least first planetary gear set is connected to a second output shaft for conjoint rotation. A first output torque is at least indirectly transmittable onto the first output shaft and a second output torque, which corresponds to the first output torque, is at least indirectly transmittable onto the second output shaft by the at least first planetary gear set. The transmission further includes a second sub-transmission, which is arranged in a second housing and has a second input shaft and a third output shaft. The second input shaft is at least indirectly connected to the second output shaft of the first sub-transmission for conjoint rotation, and the third output shaft is at least indirectly connected to a first wheel of the vehicle for conjoint rotation. The transmission additionally includes a third sub-transmission, which is arranged in a third housing and has a third input shaft and a fourth output shaft. The third input shaft is at least indirectly connected to the first output shaft of the first sub-transmission for conjoint rotation, and the fourth output shaft is at least indirectly connected to a second wheel of the vehicle for conjoint rotation. Drive power is introduceable into the transmission via the first input shaft, and the housings are fixed in place. The input torque which is applied at the first input shaft is coupled in between the first input shaft of the first sub-transmission and the first housing of the first sub-transmission.

In such a transmission, the sums of the two wheel torques are not combined to form a single axle torque in a component. Rather, the drive power introduced into the first input shaft is divided in the epicyclic gear train, which acts as a differential, and, in accordance with the design and connection of the gear set elements of the at least first planetary gear set of the epicyclic gear train, is transmitted into the first and second output shafts of the first sub-transmission, which are operatively connected thereto. Therefore, the components of the epicyclic gear train are more slender due to the respective, relatively low torque they have to accommodate. A transmission is therefore provided, which performs the two functions—torque conversion and torque distribution—via one single integral assembly by the epicyclic gear train. The invention is therefore a combined transmission and differential, which converts and distributes torque onto the first output shaft and the second output shaft.

The input torque to the input shaft is convertible by such an epicyclic gear train and is distributable and transmittable at a defined ratio onto the two output shafts. Preferably, 50%, i.e., one half, of the input torque is transmitted onto the output shafts of the first sub-transmission. In any case, the sum of the torques in the first sub-transmission must be “zero.” The output torques at the output shafts of the first sub-transmission have opposite signs. For example, an input torque, which has been normalized to “1,” at the first input shaft or at the first gear set element in the first planetary gear set is converted, for example, into a first torque “−4” at the first output shaft or at the second gear set element in the first planetary gear set and into a second torque “3” at the second output shaft or at the third gear set element in the first planetary gear set. The sum of all torques is always “0.” The first torque and the second torque are therefore unequal. Therefore, the epicyclic gear train does not have a component that is subjected to both output torques. In other words, the two torques are never combined.

The epicyclic gear train is a planetary transmission having at least a first planetary gear set including the gear set elements sun gear, ring gear, and multiple planet gears guided by a planet carrier on a circular path around the sun gear. A “planetary gear set” is understood to be a unit that includes a sun gear, a ring gear, and one or multiple planet gear(s) guided by a planet carrier on a circular path around the sun gear, wherein the planet gears are meshed with the ring gear and the sun gear. It is conceivable that the epicyclic gear train also includes one or multiple further planetary gear set(s).

The first input shaft is preferably drivingly connected to a drive unit, in particular to an electric machine or an internal combustion engine, in order to introduce a torque into the transmission. In other words, a drive torque is transmitted onto the first input shaft and converted by the epicyclic gear train and divided onto the output shafts of the first sub-transmission. The first input shaft is therefore at least indirectly connected to an input shaft of the drive unit for conjoint rotation. The drive unit generates drive power, which is transmitted via the input shaft of the drive unit onto the first input shaft of the first sub-transmission. The input shaft of the drive unit is connectable to the first input shaft of the first sub-transmission for conjoint rotation. Alternatively, the input shaft of the drive unit and the first input shaft of the first sub-transmission are a contiguous and one-piece component. Alternatively, further rotational-speed-transmitting and torque-transmitting components, in particular a differential and/or a cardan shaft and/or an angle drive, are arranged between the input shaft of the drive unit and the first input shaft of the first sub-transmission.

The housings of the sub-transmissions are components which are fixed in place. In other words, the housings are each rotationally and axially fixed. The housings are preferably at least indirectly connected to the chassis of the vehicle so as to be fixed in place. A drive torque-coupled torque of the sub-transmission is supported against the chassis of the vehicle via the housing. A corotational connection of a component to the housing is understood to be an arrangement secured to the housing. The term “secured to the housing” is understood to mean that relative motion does not takes place or cannot take place between the component secured to the housing and the housing.

The output rotational speeds of the two output shafts of the first sub-transmission preferably differ from one another, in particular when the vehicle is driving straight ahead. In this sense, the magnitudes of the torque vectors at the output shafts of the first sub-transmission differ from one another. The torques at the output shafts of the first sub-transmission preferably have opposing directions.

According to one exemplary embodiment, the first output shaft of the first sub-transmission is connected to the third input shaft of the third sub-transmission for conjoint rotation via a first coupling shaft, which extends between the first housing and the third housing. The first coupling shaft is preferably a first universal joint shaft, wherein the first universal joint shaft is operatively connected at its ends to the first output shaft of the first sub-transmission and to the third output shaft of the third sub-transmission via an appropriate joint.

The second output shaft of the first sub-transmission is preferably connected to the second input shaft of the second sub-transmission for conjoint rotation via a second coupling shaft, which extends between the first housing and the second housing. The second coupling shaft is preferably a second universal joint shaft, wherein the second universal joint shaft is operatively connected at its ends to the second output shaft of the first sub-transmission and to the second output shaft of the second sub-transmission via an appropriate joint. Alternatively, the first coupling shaft and/or the second coupling shaft is a rigid shaft which drivingly connects the first sub-transmission to the second sub-transmission and to the third sub-transmission.

The sub-transmissions are spatially separated from one another, wherein the drive power which is introduced into the first sub-transmission is divided by the epicyclic gear train and subsequently transmitted via the respective coupling shaft which is operatively connected to the first sub-transmission into the second sub-transmission and the third sub-transmission. A further torque increase is carried out in the second sub-transmission and in the third sub-transmission. Furthermore, a reversal of the direction of rotation takes place either in the second sub-transmission or in the third sub-transmission depending on the direction of rotation of the first input shaft. In this sense, the second sub-transmission brings about a reversal of the direction of rotation relative to a direction of rotation of the second output shaft, wherein the third sub-transmission does not bring about a reversal of the direction of rotation relative to a direction of rotation of the first output shaft, or vice versa.

The first sub-transmission is preferably arranged approximately in the center relative to a longitudinal axis of the vehicle, wherein the first coupling shaft and the second coupling shaft extend from the first sub-transmission in opposing directions. In other words, the first coupling shaft is oriented towards the first wheel of the vehicle, wherein the second coupling shaft is oriented towards the second wheel of the vehicle.

The second sub-transmission is arranged close to the wheel or close to the first wheel of the motor vehicle in order to optimize the installation space. By comparison, on the opposite side of the axle, the third sub-transmission is also arranged close to the wheel or close to the second wheel of the motor vehicle in order to optimize the installation space.

The first planetary gear set is preferably a negative planetary gear set. A negative planetary gear set corresponds to a planetary gear set including a planet carrier, on which first planet gears are rotatably mounted, and including a sun gear and a ring gear, wherein the teeth on at least one of the planet gears meshes with the teeth on the sun gear as well as with the teeth on the ring gear, as a result of which the ring gear and the sun gear rotate in opposite directions when the sun gear rotates while the carrier is held. Alternatively, the first planetary gear set is a positive planetary gear set. A positive planetary gear set differs from the negative planetary gear set in that the positive planetary gear set has first and second or inner and outer planet gears which are rotatably mounted on the planet carrier. The teeth of the first or inner planet gears mesh with the teeth of the sun gear and with the teeth of the second or outer planet gears. In addition, the teeth of the outer planet gears mesh with the teeth of the ring gear. As a result, the ring gear and the sun gear rotate in the same direction when the planet carrier is held.

Alternatively, it is also conceivable to form one or multiple planetary gear set(s) as a stepped planetary gear set or stepped planetary gear sets. Each stepped planetary gear of the particular stepped planetary gear set preferably has a first gear wheel with a second gear wheel, which is connected thereto for conjoint rotation. The first gear wheel is preferably meshed, for example, with the sun gear and the second gear wheel is therefore meshed with the ring gear, or vice versa. These two gear wheels are connectable to one another for conjoint rotation, for example, via an intermediate shaft or a hollow shaft. In the case of a hollow shaft, the hollow shaft is rotatably mountable on a pin of the planet carrier. The two gear wheels in the particular stepped planetary gear preferably have different diameters and numbers of teeth in order to set a gear ratio. Composite planetary gear sets are also conceivable.

In principle, the planetary gear sets in the transmission, in particular in the integral differential and the epicyclic gear train, are arbitrarily arranged with respect to one another and arbitrarily operatively connected to one another in order to implement a desired gear ratio. According to one exemplary embodiment, the first gear set element is a sun gear in the planetary gear set, the second gear set element is a planet carrier in the planetary gear set, and the third gear set element is a ring gear in the planetary gear set. According to one example, the first input shaft of the first sub-transmission is connected to the sun gear in the first planetary gear set in the epicyclic gear train for conjoint rotation, wherein the planet carrier in the first planetary gear set in the epicyclic gear train is connected to the first output shaft of the first sub-transmission for conjoint rotation and the ring gear in the first planetary gear set of the epicyclic gear train is connected to the second output shaft of the first sub-transmission for conjoint rotation.

According to one exemplary embodiment, the second sub-transmission is a first spur gear drive which includes a first gear wheel, which is connected to the second input shaft for conjoint rotation and is meshed with a second gear wheel, which is connected to the third output shaft for conjoint rotation. The gear wheels in the first spur gear drive each have external teeth, which mesh with one another. Depending on the diameter and the numbers of teeth of the first and the second gear wheels, a torque increase, a torque decrease, a rotational-speed increase, or a rotational-speed decrease is carried out by the second sub-transmission. Moreover, the second sub-transmission brings about a reversal of the direction of rotation of the second output shaft of the first sub-transmission or of the second input shaft of the second sub-transmission onto the third output shaft of the second sub-transmission, provided that a reversal of the direction of rotation does not take place at the third sub-transmission.

Alternatively, the second sub-transmission is a first planetary transmission with a second planetary gear set, wherein a first gear set element in the second planetary gear set is connected to the second input shaft for conjoint rotation, wherein a second gear set element in the second planetary gear set is fixed in place on the second housing, and wherein a third gear set element in the second planetary gear set is connected to the third output shaft for conjoint rotation. A change in torque and/or rotational speed is also carried out by the second planetary gear set. In addition, a reversal of the direction of rotation of the second output shaft of the first sub-transmission or of the second input shaft of the second sub-transmission onto the third output shaft of the second sub-transmission is carried out. The second planetary gear set in the first planetary transmission is preferably a negative planetary gear set. With respect to the second planetary gear set, reference is made to the comments presented regarding the first planetary gear set in the epicyclic gear train. In particular, the first gear set element is a sun gear in the second planetary gear set, the second gear set element is a planet carrier in the second planetary gear set, and the third gear set element is a ring gear in the second planetary gear set. Therefore, the support against the housing takes place via the planet carrier in the second planetary gear set.

According to a further exemplary embodiment, the third sub-transmission is a first flexible traction drive mechanism, which includes a first traction mechanism wheel which is connected to the third input shaft for conjoint rotation and is drivingly connected via a traction mechanism to a second traction mechanism wheel, which is connected to the fourth output shaft for conjoint rotation. The traction drive is, for example, a belt drive or a chain drive, wherein the traction mechanism is, therefore, a belt or a chain. In particular, the traction drive is a flexible traction drive mechanism. Depending on the diameter of the traction mechanism wheels, a change in torque and/or rotational speed is implemented by the third sub-transmission, wherein the direction of rotation of the first output shaft of the first sub-transmission or of the third input shaft of the third sub-transmission and of the fourth output shaft of the third sub-transmission remains the same, provided that a reversal of the direction of rotation takes place at the second sub-transmission.

Alternatively, the third sub-transmission is a second spur gear drive, which includes a third gear wheel which is at least indirectly connected to the third input shaft for conjoint rotation and has external teeth, the third gear wheel meshing with a fourth gear wheel which has internal teeth and is connected to the fourth output shaft for conjoint rotation. The third gear wheel is formed essentially similarly to the above-described first and second gear wheels, whereas the fourth gear wheel is a ring gear which radially accommodates the third gear wheel and meshes therewith. Therefore, the third and the fourth gear wheels rotate in the same direction.

Further alternatively, the third sub-transmission is a second planetary transmission with a third planetary gear set, wherein a first gear set element in the third planetary gear set is at least indirectly connected to the third input shaft for conjoint rotation, wherein a second gear set element in the third planetary gear set is connected to the fourth output shaft for conjoint rotation, and wherein a third gear set element in the third planetary gear set is fixed in place on the third housing. A change in torque and/or rotational speed is also carried out by the third planetary gear set. The gear set elements are connected such that the third input shaft and the fourth output shaft preferably rotate in the same direction, provided that a reversal of the direction of rotation takes place at the second sub-transmission. The third planetary gear set in the second planetary transmission is preferably a negative planetary gear set. With respect to the third planetary gear set, reference is made to the comments presented regarding the first planetary gear set in the epicyclic gear train. In particular, the first gear set element is a sun gear in the third planetary gear set, the second gear set element is a planet carrier in the third planetary gear set, and the third gear set element is a ring gear in the third planetary gear set. Therefore, the support against the housing takes place via the ring gear in the third planetary gear set.

Further alternatively, the third sub-transmission is a third spur gear drive which is formed as a gear train and includes a fifth gear wheel, which is connected to the third input shaft for conjoint rotation, and a sixth gear wheel, which is connected to the fourth output shaft for conjoint rotation, wherein the fifth and the sixth gear wheels are meshed with a seventh gear wheel, which is rotatably mounted on an intermediate shaft. The gear wheels are designed essentially similarly to the above-described first and second gear wheels.

Further alternatively, the third sub-transmission consists only of a rigidly coupled input and output shaft. In other words, all that takes place at the third sub-transmission is a pass-through of the coupling shaft, wherein the third housing is dispensed with or designed such that a drive torque-coupled torque is not introduced into the chassis. The third input shaft and the fourth output shaft are connected to each other for conjoint rotation or are formed in one piece.

With respect to the aforementioned comments presented regarding the third sub-transmission, a change in torque and/or rotational speed is implemented depending on the diameter of the third and the fourth gear wheels, wherein the direction of rotation of the first output shaft of the first sub-transmission or of the third input shaft of the third sub-transmission and of the fourth output shaft of the third sub-transmission remains the same.

Conversely, it is also conceivable that the transmission is designed such that a reversal of the direction of rotation relative to a direction of rotation of the first output shaft is brought about by the third sub-transmission, wherein, correspondingly, a reversal of the direction of rotation relative to a direction of rotation of the second output shaft is not brought about by the second sub-transmission.

A “shaft” is understood to be a rotatable component in the transmission with which various components in the transmission are connected to one another for conjoint rotation. The shaft connects the components to one another axially or radially, or also both axially and radially. A shaft is not to be understood exclusively to be a, for example, cylindrical, rotatably mounted machine element for transmitting torques, but rather a shaft is also understood to refer to general connecting elements that connect individual components or elements to one another, in particular, connecting elements that connect multiple elements to one another for conjoint rotation.

If two components in the transmission are “connected or coupled for conjoint rotation,” this means, as set forth in the invention, that there is a permanent connection between components, such that they cannot rotate independently of one another. This is therefore also understood to be a permanent rotary joint. In particular, there are no shift elements between these components, which are elements in the integral differential, and/or shafts, and/or a nonrotating component in the transmission, but instead, these components are permanently coupled to one other. An elastically rotating connection between two components is also understood to be permanent, or such that the elements rotate conjointly. In particular, a corotational connection also includes joints, for example, in order to allow for a steering motion or the springing of a wheel.

The terms “operatively connected” and “drivingly connected” are understood to be a permanent connection between two components, the permanent connection being provided for permanently transmitting drive power, in particular rotational speed and/or torque. The connection is implemented directly or via a fixed ratio. The connection is implemented, for example, via a fixed shaft, gear teeth, in particular on a spur gear, and/or with a belt.

The term “at least indirectly” is understood to mean that two components are (operatively) connected to one another via at least one other component, located between the two components, or that the two components are directly connected to one another. Other components are also arranged between shafts or gear wheels, which are operatively connected to the shaft or to the gear wheel.

Further interconnected components are arranged between the first input shaft of the first sub-transmission and the drive unit, which are formed, for example, as a planetary transmission, a spur gear drive, a chain drive, a belt drive, an angle drive, a universal joint shaft, a torsional shock absorber, a multi-speed transmission or the like. Further interconnected components are also arranged between the particular output shaft of the second or the third sub-transmission and the wheel operatively connected thereto, such as, for example, universal joint shafts, transmission gearing, spring and damping elements or the like.

A power train according to the invention for a vehicle according to a second aspect of the invention has a transmission as described above and a drive unit, which is operatively connected to the transmission. According to one exemplary embodiment, the drive unit is an electric machine, wherein the first input shaft of the transmission is a rotor of the electric machine or is connected or coupled to the rotor or to a rotor shaft of the electric machine for conjoint rotation. In this sense, the first input shaft is at least indirectly drivingly connected to a drive unit which is formed as an electric machine. The rotor is mounted for rotation with respect to a stator in the electric machine, the stator being secured to the housing. The stator is fixed in place on the first housing. The electric machine is preferably connected to an accumulator, which supplies the electric machine with electrical energy. Moreover, the electric machine is preferably controllable by an open-loop or closed-loop system by a power electronics system.

Alternatively, the drive unit is also an internal combustion engine, wherein the first input shaft in this case is, for example, a crankshaft, is connected or coupled to the crankshaft for conjoint rotation or is drivingly connected to a crankshaft of the internal combustion engine. In this sense, the first input shaft is preferably at least indirectly drivingly connected to a drive unit, which is an internal combustion engine, via an angle drive. In other words, the internal combustion engine is not integrated in the first housing. Drive power of the internal combustion engine is transmitted onto the first input shaft, for example, via a shaft, in particular a cardan shaft. When the crankshaft of the internal combustion engine is arranged in the longitudinal axis of the vehicle, it is useful to transmit the drive power via an angle drive into the first input shaft, which is arranged transversely to the longitudinal axis of the vehicle. The angle drive is, for example, a bevel gear and a crown wheel.

The power train of the type described above is usable in a vehicle. The vehicle is preferably a motor vehicle, in particular an automobile (for example, a passenger car weighing less than 3.5 tons), a bus, or a truck (busses and trucks weighing more than 3.5 tons). The vehicle has at least two axles, in which one of the axles is formed by a drive axle that is drivable by the power train. The power train according to the invention is operatively arranged on this drive axle and the power train transmits drive power from the drive unit onto the wheels on this axle via the transmission according to the invention. It is also conceivable that there is a separate power train of this type for each axle. The power train is preferably front-wheel drive, in which the input shafts and the output shafts are substantially transverse to the longitudinal axis of the vehicle.

The above definitions and explanations of technological effects, advantages and advantageous embodiments of the transmission according to the invention also apply analogously to the power train according to the invention, and vice versa.

### BRIEF DESCRIPTION OF THE DRAWINGS

Four exemplary embodiments of the invention are explained in greater detail in the following with reference to the schematic drawings. Therein:

FIG. 1 shows a highly schematic view of a vehicle with a power train according to the invention and a transmission according to the invention, and

FIG. 2 shows a schematic view of the transmission of the power train according to the invention from FIG. 1 according to a first embodiment,

FIG. 3 shows a schematic view of a first sub-transmission of the transmission according to the invention from FIG. 2,

FIG. 4 shows a schematic view of the first sub-transmission of the transmission according to the invention according to a second embodiment,

FIG. 5 shows a schematic view of the transmission of the power train according to the invention according to a third embodiment,

FIG. 6 shows a schematic view of the transmission of the power train according to the invention according to a fourth embodiment, and

FIG. 7 shows a schematic view of the transmission of the power train according to the invention according to a fifth embodiment.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

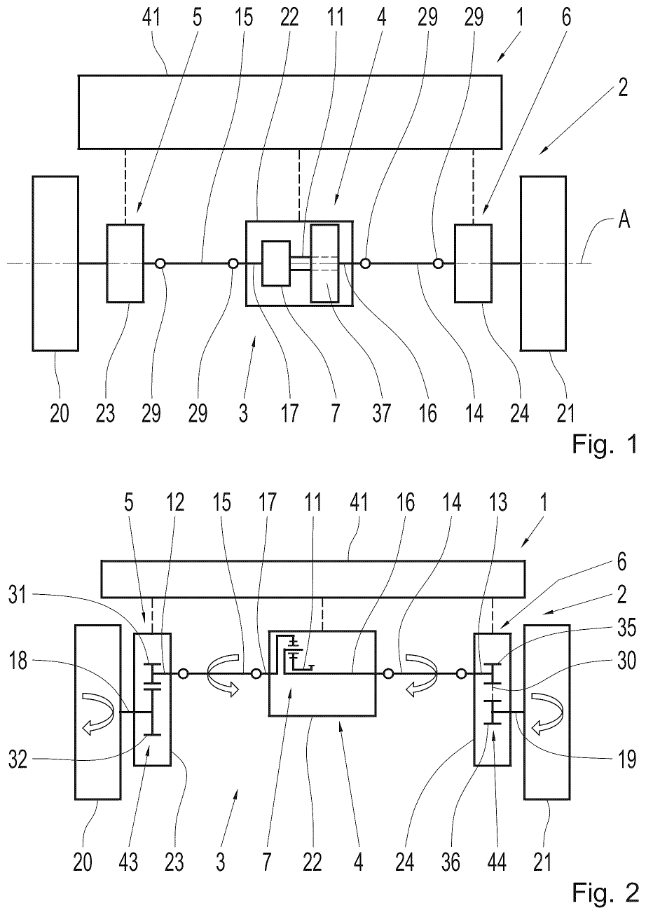

FIG. 1 shows a highly simplified vehicle 1, wherein the vehicle 1 has two axles, namely a first axle A and a second axle (which is concealed here). The axle A is shown only in FIG. 1. A power train 2 according to the invention is drivingly arranged on the first axle A. The first axle A is either the front axle or the rear axle of the vehicle 1 and is a driven axle of the vehicle 1, as described below.

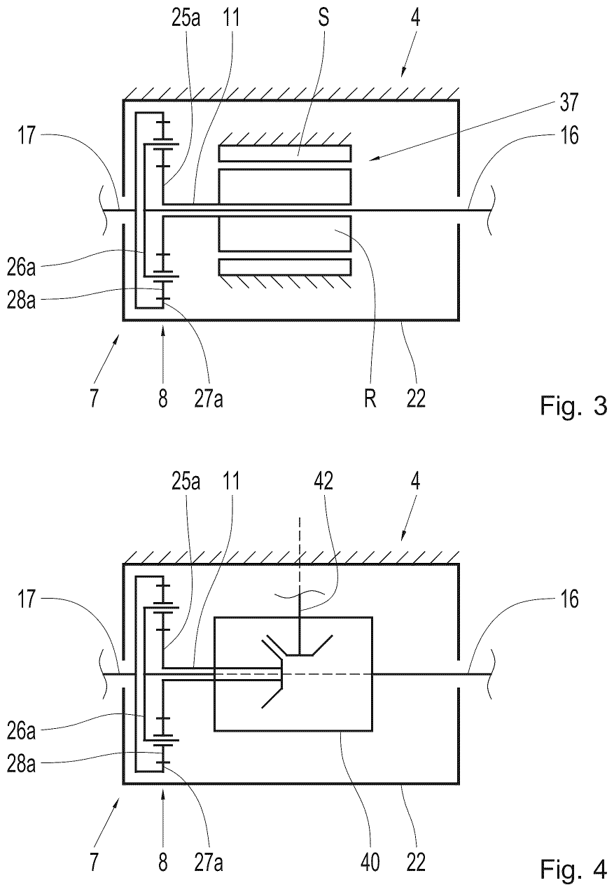

The power train 2 according to a first embodiment includes, according to FIG. 3, a drive unit 37 which is an electric machine and is operatively connected to a transmission 3. The design and the arrangement of the power train 2 in the vehicle 1, in particular of the transmission 3, is explained in greater detail in the following figures. A view of the drive unit 37 is omitted in FIG. 2 and FIGS. 5-7 for the sake of simplicity. In any case, the drive power of the drive unit 37 is introduced via a first input shaft 11. The electric machine is supplied with electrical energy via an accumulator (not shown here), which is operatively connected to a stator S secured to the housing. Moreover, the electric machine 37 is connected to a power electronics system (not shown here) for open-loop control and closed-loop control. As shown in FIG. 3, a rotor R, which is mounted for rotation with respect to the stator S and is connected, as a drive shaft, to the first input shaft 11 for conjoint rotation, is set into a rotational movement in relation to the stator S by energizing the stator S. Alternatively, the first input shaft 11 is connected to a separate rotor shaft (not shown) of the rotor R for conjoint rotation or coupled thereto. The drive power of the drive unit 37 is directed via the first input shaft 11 into a first sub-transmission 4 of the transmission 3, the first sub-transmission 4 being arranged in a first housing 22, and the drive power is converted in the first sub-transmission 4 by an epicyclic gear train 7 and at least indirectly divided onto a first output shaft 16 and a second output shaft 17. The drive unit 37, including the stator S and the rotor R, is coaxial to the epicyclic gear train 7. The output shafts 16, 17 are coaxial to each other and extend from the epicyclic gear train 7 in opposing directions toward the wheels 20, 21 (FIG. 1) of the vehicle 1. In the present case, the first output shaft 16 extends to the right and the second output shaft 17 extends to the left. The input torque of the drive unit 37 is coupled in between the first input shaft 11 of the first sub-transmission 4 and the first housing 22 of the first sub-transmission 4.

In an alternative embodiment from FIG. 4, the drive unit 37 (not shown) is an internal combustion engine. The drive unit 37 is arranged on the second axle of the vehicle 1. In this case, the drive power of the drive unit 37 is transmitted onto the first input shaft 11 of the first sub-transmission 4 via a cardan shaft 42, which is arranged essentially perpendicularly to the first input shaft 11, and an angle drive 40. The embodiment of the drive unit 37 as an electric machine appears particularly suitable, however, due to lack of space.

As is clearly shown in FIG. 3 and FIG. 4, the epicyclic gear train 7 has a single planetary gear set 8 with multiple gear set elements. In the present case, a first gear set element of the first planetary gear set 8 is a first sun gear 25a, a second gear set element is a first planet carrier 26a, and a third gear set element is a first ring gear 27a, wherein multiple first planet gears 28a, which are meshed with the first sun gear 25a and the first ring gear 26a, are rotatably mounted on the first planet carrier 26a. The epicyclic gear train 7 is therefore a negative planetary gear set in the present case. A first ratio of the transmission 3 is already implemented by the epicyclic gear train 7. Transmission parts which are situated downstream in the power flow, in particular a second sub-transmission 5 and/or a third sub-transmission 6, is therefore made smaller and more compact.

The first sun gear 25a is connected to a first input shaft 11 for conjoint rotation, the first planet carrier 26a is connected to the first output shaft 16 for conjoint rotation, and the first ring gear 27a is connected to the second output shaft 17 for conjoint rotation. By the first planetary gear set 8, a first output torque is at least indirectly transmittable onto the first output shaft 16 and a second output torque, which corresponds to the first output torque, is at least indirectly transmittable onto the second output shaft 17. In other words, an input torque is divided into two output torques by the epicyclic gear train 7, wherein the sum of all torques in the first sub-transmission 4 is “zero.”

Different embodiments of the transmission 3 are shown in FIG. 2 and FIGS. 5-7. The transmission 3 is a differential gear, wherein a torque conversion and a torque distribution onto a second sub-transmission 5 and a third sub-transmission 6 each operatively connected to the first sub-transmission 4 is carried out by the epicyclic gear train 7. The first sub-transmission 4 is arranged approximately in the center of the vehicle 1, wherein the second sub-transmission 5, which is arranged in a second housing 23, is arranged at the first wheel 20 shown on the left, and the third sub-transmission 6, which is arranged in a third housing 24, is arranged at the second wheel 21 shown on the right, the second and the third sub-transmissions being arranged close to the respective wheels. This optimizes, in particular, the ground clearance of the vehicle 1.

The second sub-transmission 5, which is shown in FIG. 2 and FIGS. 5-7, has a second input shaft 12 and a third output shaft 18. The second output shaft 17 of the first sub-transmission 4 is connected to the second input shaft 12 of the second sub-transmission 5 for conjoint rotation via a second coupling shaft 15. The second coupling shaft 15, as a universal joint shaft, is arranged between two joints 29 (FIG. 1) and extends between the first housing 22 and the second housing 23, and between the second output shaft 17 and the second input shaft 12. The third output shaft 18 is at least indirectly connected (in a manner not shown here in greater detail) to the first wheel 20 of the vehicle 1 for conjoint rotation.

The third sub-transmission 6, which is shown in FIG. 2 and FIGS. 5-7, has a third input shaft 13 and a fourth output shaft 19. The first output shaft 16 of the first sub-transmission 4 is connected to the third input shaft 13 of the third sub-transmission 6 for conjoint rotation via a first coupling shaft 14. The first coupling shaft 14, which is also a universal joint shaft, is arranged between two joints 29 (FIG. 1) and extends between the first housing 22 and the second housing 24, and between the first output shaft 16 and the third input shaft 13. The fourth output shaft 19 is at least indirectly connected (in a manner not shown here in greater detail) to the second wheel 21 of the vehicle 1 for conjoint rotation. The joints 29 and the coupling shafts 14, 15 compensate possible slanted positions of the shafts connected thereto. Each housing 22, 23, 24 in all exemplary embodiments is fastened in a positionally fixed manner on a chassis 41 of the vehicle 1. It is not possible to turn the housings 22, 23, 24 in relation to the chassis 41, whereas a relative motion within the scope of the springing of the chassis is possible.

In the present examples, the second sub-transmission 5 reverses the direction of rotation between the second input shaft 12 and the third output shaft 18, whereas the third sub-transmission 6 does not reverse the direction of rotation between the third input shaft 13 and the fourth output shaft 19. As a result, function-related opposing directions of rotation of the output shafts 16, 17 of the epicyclic gear train 7 of the first sub-transmission 4 are compensated. The directions of rotation of the shafts are shown in FIG. 2 and FIGS. 5-7 by the curved arrows in the region of the coupling shafts 14, 15 and at the wheels 20, 21.

According to FIG. 2, the second sub-transmission 5 is a first spur gear drive 43, including a first gear wheel 31, which is connected to the second input shaft 12 of the second sub-transmission 5 for conjoint rotation, and a second gear wheel 32, which is meshed with the first gear wheel 31 and is connected to the third output shaft 18 of the second sub-transmission 5 for conjoint rotation. The third sub-transmission 6, which is arranged on the opposite side of the first sub-transmission 4, is a first flexible traction drive mechanism 44 as a toothed-belt drive in the present case, including a first traction mechanism wheel 35, which is connected to the third input shaft 13 of the third sub-transmission 6 for conjoint rotation and drivingly connected to a second traction mechanism wheel 36 via a traction mechanism 30 as a belt, the second traction mechanism wheel 36 being connected to the fourth output shaft 19 of the third sub-transmission 6 for conjoint rotation. A transmission 3 having greater ground clearance for the vehicle 1 is therefore realized. The traction mechanism 30 is indicated by a dashed line.

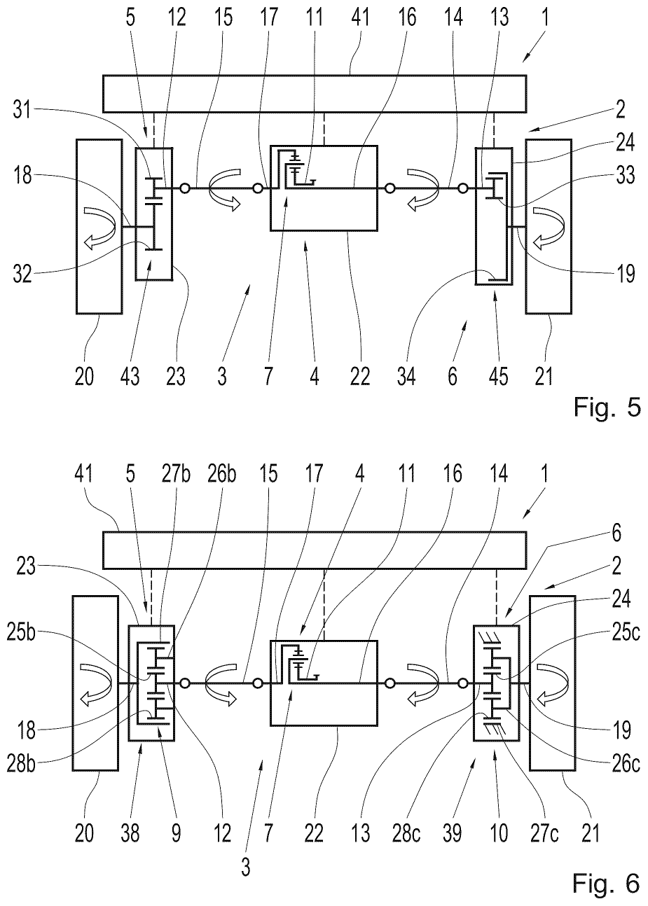

According to FIG. 5, the second sub-transmission 5 is identical to the exemplary embodiment from FIG. 2, except that, according to FIG. 5, the third sub-transmission 6 is a second spur gear drive 45, including a third gear wheel 33 which has external teeth and is at least indirectly connected to the third input shaft 13 of the third sub-transmission 6 for conjoint rotation, the third gear wheel 33 meshing with a fourth gear wheel 34, which has internal teeth and is a ring gear, the fourth gear wheel 34 being connected to the fourth output shaft 19 of the third sub-transmission 6 for conjoint rotation. A transmission 3 having greater ground clearance for the vehicle 1 is therefore realized.

According to FIG. 6, the second sub-transmission 5 is a first planetary transmission 38 with a second planetary gear set 9. A first gear set element of the second planetary gear set 9 is a second sun gear 25b, a second gear set element is a second planet carrier 26b, and a third gear set element is a second ring gear 27b, wherein multiple second planet gears 28b are rotatably mounted on the second planet carrier 26b, the second planet gears 28b meshing with the second sun gear 25b and the second ring gear 27b. The second sun gear 25b is connected to the second input shaft 12 of the second sub-transmission 5 for conjoint rotation. The second planet carrier 26b is fixed in place and is supported against the second housing 23 of the second sub-transmission 5. The second ring gear 27b is connected to the third output shaft 18 of the second sub-transmission 5 for conjoint rotation.

The third sub-transmission 6 in FIG. 6 is a second planetary transmission 39 with a third planetary gear set 10. A first gear set element of the third planetary gear set 10 is a third sun gear 25c, a second gear set element is a third planet carrier 26c, and a third gear set element is a third ring gear 27c, wherein multiple third planet gears 28c are rotatably mounted on the third planet carrier 26c, the third planet gears 28c meshing with the third sun gear 25c and the third ring gear 27c. The third sun gear 25c of the third planetary gear set 10 is connected to the third input shaft 13 of the third sub-transmission 6 for conjoint rotation, wherein the third planet carrier 26c is connected to the fourth output shaft 19 of the third sub-transmission 6 for conjoint rotation. The third ring gear 27c is fixed in place on the third housing 24. Such sub-transmissions 5, 6 are particularly compact, such that the necessary installation space in the region of the particular wheel 20, 21 is further reduced.

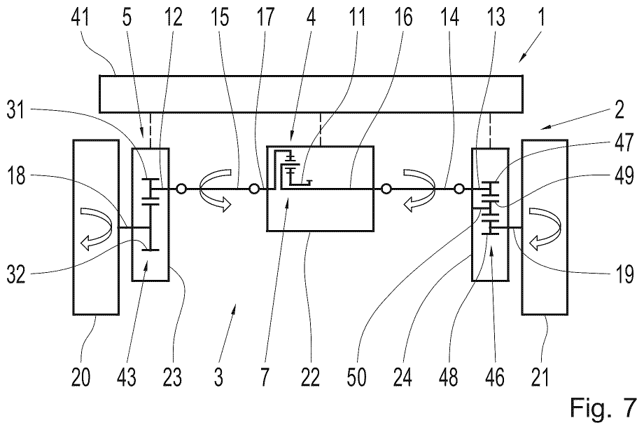

According to FIG. 7, the second sub-transmission 5 is identical to the exemplary embodiment from FIG. 2, except, in the present case, the third sub-transmission 6 is a third spur gear drive 46 which is a gear train that includes a fifth gear wheel 47, which is connected to the third input shaft for conjoint rotation, and a sixth gear wheel 48, which is connected to the fourth output shaft 19 for conjoint rotation, wherein the fifth and the sixth gear wheels 47, 48 are meshed with a seventh gear wheel 49, which is rotatably mounted on an intermediate shaft 50. The intermediate shaft 50 is mounted for rotation with respect to the third housing 24. A transmission 3 having greater ground clearance for the vehicle 1 is therefore realized.

All exemplary embodiments have the advantage that low housing supported torques are applied at the housings.

The output rotational speeds of the two output shafts 16, 17 of the first sub-transmission 4 differ from one another, in particular when the vehicle 1 is driving straight ahead. In other words, a magnitude of the torque vectors differs at the output shafts 16, 17 of the first sub-transmission 4. The torques have opposing directions at the output shafts 16, 17 of the first sub-transmission 4.

It is explicitly pointed out that the assignment of the gear set elements to the elements in the particular planetary gear set 8, 9, 10 is arbitrarily interchangeable. With respect to the second and the third planetary gear sets 9, 10, however, a reversal of the direction of rotation of the input shaft and of the output shaft is implementable by one of the two planetary gear sets, although this is not the case with the respective other planetary gear set. Instead of a negative planetary gear set, the first planetary gear set 8 is a positive planetary gear set by interchanging the connection of the planet carrier and the ring gear and increasing the absolute value of the stationary gear ratio by one. Correspondingly, the other way around is also possible. In particular, the first and the second planetary transmissions 38, 39 have two or more planetary gear sets. Furthermore, it is conceivable to arrange additional gear stages or transmission gearings between the drive unit 37 and the epicyclic gear train 7, which are, for example, a planetary transmission having one or multiple planetary gear set(s), in order to increase a stationary gear ratio of the drive.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 vehicle
2 power train
3 transmission
4 first sub-transmission
5 second sub-transmission
6 third sub-transmission
7 epicyclic gear train
8 first planetary gear set
9 second planetary gear set
10 third planetary gear set
11 first input shaft
12 second input shaft
13 third input shaft
14 first coupling shaft
15 second coupling shaft
16 first output shaft
17 second output shaft
18 third output shaft
19 fourth output shaft
20 first wheel of the vehicle
21 second wheel of the vehicle
22 first housing
23 second housing
24 third housing
25a first sun gear in the first planetary gear set
25b second sun gear in the second planetary gear set
25c third sun gear of the third planetary gear set
26a first planet carrier in the first planetary gear set
26b second planet carrier in the second planetary gear set
26c third planet carrier in the third planetary gear set
27a first ring gear in the first planetary gear set
27b second ring gear in the second planetary gear set
27c third ring gear in the third planetary gear set
28a first planet gear in the first planetary gear set
28b second planet gear in the second planetary gear set
28c third planet gear in the third planetary gear set
29 joint
30 traction mechanism
31 first gear wheel
32 second gear wheel
33 third gear wheel
34 fourth gear wheel
35 first traction mechanism wheel
36 second traction mechanism wheel
37 drive unit
38 first planetary transmission
39 second planetary transmission
40 angle drive
41 chassis
42 cardan shaft
43 first spur gear drive
44 flexible traction drive mechanism
second spur gear drive
46 third spur gear drive
47 fifth gear wheel
48 sixth gear wheel
49 seventh gear wheel
50 intermediate shaft
A axle
R rotor
S stator

1-15: (canceled)

16. A transmission (3) for a power train (2) of a vehicle (1), comprising:
a first housing (22);
a first sub-transmission (4) in the first housing (22), the first sub-transmission (4) having:
a first input shaft (11), drive power being introduceable into the transmission (3) via the first input shaft (11);
a first output shaft (16);
a second output shaft (17); and
an epicyclic gear train (7) with a first planetary gear set (8), the first planetary gear set (8) having a first gear set element connected to the first input shaft (11) for conjoint rotation, a second gear set element connected to the first output shaft (16) for conjoint rotation, and a third gear set element connected to the second output shaft (17) for conjoint rotation, a first output torque being at least indirectly transmittable onto the first output shaft (16) and a second output torque being at least indirectly transmittable onto the second output shaft (17) by the first planetary gear set (8), the second output torque corresponding to the first output torque;
a second housing (23);
a second sub-transmission (5) in the second housing (23), the second sub-transmission (5) having a second input shaft (12) and a third output shaft (18), the second input shaft (12) being at least indirectly connected to the second output shaft (17) of the first sub-transmission (4) for conjoint rotation, the third output shaft (18) being at least indirectly connected to a first wheel (20) of the vehicle (1) for conjoint rotation;
a third housing (24), the first, second, and third housings (22, 23, 24) being fixed; and
a third sub-transmission (6) in the third housing (24), the third sub-transmission (6) having a third input shaft (13) and a fourth output shaft (19), the third input shaft (13) being at least indirectly connected to the first output shaft (16) of the first sub-transmission (4) for conjoint rotation, the fourth output shaft (19) being at least indirectly connected to a second wheel (21) of the vehicle (1) for conjoint rotation.

17. The transmission (3) of claim 16, wherein the first output shaft (16) of the first sub-transmission (4) is connected to the third input shaft (13) of the third sub-transmission (6) for conjoint rotation via a first coupling shaft (14), the first coupling shaft (14) extending between the first housing (22) and the third housing (24).

18. The transmission (3) of claim 16, wherein the second output shaft (17) of the first sub-transmission (4) is connected to the second input shaft (12) of the second sub-transmission (5) for conjoint rotation via a second coupling shaft (15), the second coupling shaft (15) extending between the first housing (22) and the second housing (23).

19. The transmission (3) of claim 16, wherein the first input shaft (11) is drivingly connected to a drive unit (37) to introduce a torque into the transmission (3), the drive unit (37) being an electric machine or an internal combustion engine.

20. The transmission (3) of claim 16, wherein the first planetary gear set (8) is a negative planetary gear set.

21. The transmission (3) of claim 16, wherein:
a direction of rotation of the third output shaft (18) is opposite a direction of rotation of the second output shaft (17) and a direction of rotation of the fourth output shaft (19) is the same as a direction of rotation of the first output shaft (16); or
the direction of rotation of the third output shaft (18) is the same as the direction of rotation of the second output shaft (17) and the direction of rotation of the fourth output shaft (19) opposite the direction of rotation of the first output shaft (16).

22. The transmission (3) of claim 21, wherein the second sub-transmission (5) is a first spur gear drive, the first spur gear drive including a first gear wheel (31) connected to the second input shaft (12) for conjoint rotation, and a second gear wheel (32) connected to the third output shaft (18) for conjoint rotation, the first gear wheel (31) being meshed with the second gear wheel (32).

23. The transmission (3) of claim 21, wherein the second sub-transmission (5) is a first planetary transmission (38), the first planetary transmission (38) having a second planetary gear set (9), a first gear set element in the second planetary gear set (9) being connected to the second input shaft (12) for conjoint rotation, a second gear set element in the second planetary gear set (9) being fixed on the second housing (23), and a third gear set element in the second planetary gear set (9) being connected to the third output shaft (18) for conjoint rotation.

24. The transmission (3) of claim 23, wherein the first gear set element of the second planetary gear set (9) is a sun gear, the second gear set element of the second planetary gear set (9) is a planet carrier, and the third gear set element of the second planetary gear set (9) is a ring gear.

25. The transmission (3) of claim 21, wherein the third sub-transmission (6) is a first flexible traction drive mechanism (44), the first flexible traction drive mechanism (44) including a first traction mechanism wheel (35) connected to the third input shaft (13) for conjoint rotation, a second traction mechanism wheel (36) connected to the fourth output shaft (19) for conjoint rotation, and a traction mechanism (30) drivingly connecting the first traction mechanism wheel (35) and the second traction mechanism wheel (36).

26. The transmission (3) of claim 21, wherein the third sub-transmission (6) is a second spur gear drive (45), the second spur gear drive (45) including a third gear wheel (33) at least indirectly connected to the third input shaft (13) for conjoint rotation and has external teeth, a fourth gear wheel (34) having internal teeth and being connected to the fourth output shaft (19) for conjoint rotation, the third gear wheel (33) meshing with the fourth gear wheel (34).

27. The transmission (3) of claim 21, wherein the third sub-transmission (6) is a second planetary transmission (39), the second planetary transmission (39) having a third planetary gear set (10), a first gear set element in the third planetary gear set (10) being at least indirectly connected to the third input shaft (13) for conjoint rotation, a second gear set element in the third planetary gear set (10) being connected to the fourth output shaft (19) for conjoint rotation, and a third gear set element in the third planetary gear set (10) being fixed on the third housing (24).

28. The transmission (3) of claim 27, wherein the first gear set element of the third planetary gear set (10) is a sun gear, the second gear set element of the third planetary gear set (10) is a planet carrier, and the third gear set element of the third planetary gear set (10) is a ring gear.

29. The transmission (3) of claim 16, wherein the first gear set element of the first planetary gear set (8) is a sun gear, the second gear set element of the first planetary gear set (8) is a planet carrier, and the third gear set element of the first planetary gear set (8) is a ring gear.

30. A power train (2) for a vehicle (1), comprising:
the transmission (3) of claim 16; and
a drive unit (37) operatively connected to the transmission (3).

31. The power train (2) of claim 30, wherein the first input shaft (11) is at least indirectly drivingly connected via an angle drive (40) to the drive unit (37), the drive unit (37) being an internal combustion engine.

32. The power train (2) of claim 30, wherein the first input shaft (11) is at least indirectly drivingly connected to the drive unit (37), the drive unit (37) being an electric machine.
